(19) United States
(12) Patent Application Publication
(10) Pub. No.: US 2026/0252576 A1
(43) Pub. Date: Aug. 27, 2026

(54) Refining Ambiguous Retrieval-Augmented Generation Queries Through User Feedback

(71) Applicant: GDM Holding LLC, Mountain View, CA (US)

(72) Inventors: Florian Nils Hartmann, Zurich (CH); Duc-Hieu Tran, Zurich (CH)

(21) Appl. No.: 19/060,393

(22) Filed: Feb. 21, 2025

(51) Int. Cl. G06F 16/248; G06F 16/28; G06F 40/30

(52) U.S. Cl. CPC G06F 16/248; G06F 16/285; G06F 40/30

(57) ABSTRACT

The present disclosure provides methods, systems, and devices for refining ambiguous retrieval-augmented generation queries through user feedback. A system receives a query. The system generates a set of retrieval results. The system determines a diversity score for the set of retrieval results. In accordance with a determination that the diversity score for the set of retrieval results exceeds a threshold value, the system generates a plurality of retrieval result clusters. The system obtains a plurality of representative items, each representative item representing a respective retrieval result cluster in the plurality of retrieval result clusters. The system receives selection data that selects one or more of the representative items. The system updates the set of retrieval results based on the selection data. The system processes the query and the updated set of retrieval results with a sequence processing model to generate a model output from the sequence processing model.

### FIELD

The present disclosure relates generally to machine learning processes and machine-learned devices and systems. More particularly, the present disclosure relates to refining queries for retrieving supplemental information through user feedback.

### BACKGROUND

A response generation system can receive input(s). The response generation system can execute instructions to process the input(s) to generate output(s) using a machine-learned model. The response generation system can access supplemental information to increase the accuracy of the generated output. In some examples, the input can include terms that are ambiguous. As a result, the supplemental information can include documents or data that are not relevant to the input. This non-relevant data can reduce the accuracy of the output.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include receiving, by a computing system with one or more processors, a query. The method can further include generating, by the computing system, a set of retrieval results based on the query. The method can further include determining, by the computing system, a diversity score for the set of retrieval results. The method can further include, in accordance with a determination that the diversity score for the set of retrieval results exceeds a threshold value, generating, by the computing system, a plurality of retrieval result clusters based on the set of retrieval results. The method can further include obtaining, by the computing system, a plurality of representative items, each representative item representing a respective retrieval result cluster in the plurality of retrieval result clusters. The method can further include receiving, by the computing system, selection data that selects one or more of the representative items. The method can further include updating, by the computing system, the set of retrieval results based on the selection data. The method can further include processing, by the computing system, the query and the updated set of retrieval results with a sequence processing model to generate a model output from the sequence processing model.

Example aspects of the present disclosure provide an example computing system that includes one or more processors and one or more example non-transitory computer-readable media storing instructions that are executable by one or more processors to cause a computing system to perform example operations. In some implementations, the example operations can include receiving a query. The operations can further include generating a set of retrieval results based on the query. The operations can further include determining a diversity score for the set of retrieval results. The operations can further include, in accordance with a determination that the diversity score for the set of retrieval results exceeds a threshold value, generating a plurality of retrieval result clusters based on the set of retrieval results. The operations can further include obtaining a plurality of representative items, each representative item representing a respective retrieval result cluster in the plurality of retrieval result clusters. The operations can further include receiving selection data that selects one or more of the representative items. The operations can further include updating the set of retrieval results based on the selection data. The operations can further include processing the query and the updated set of retrieval results with a sequence processing model to generate a model output from the sequence processing model.

Example aspects of the present disclosure provide a non-transitory computer-readable media storing instructions that are executable by one or more processors to cause a computing system to perform example operations. In some implementations, the example operations can include receiving a query. The operations can further include generating a set of retrieval results based on the query. The operations can further include determining a diversity score for the set of retrieval results. The operations can further include, in accordance with a determination that the diversity score for the set of retrieval results exceeds a threshold value, generating a plurality of retrieval result clusters based on the set of retrieval results. The operations can further include obtaining a plurality of representative items, each representative item representing a respective retrieval result cluster in the plurality of retrieval result clusters. The operations can further include receiving selection data that selects one or more of the representative items. The operations can further include updating the set of retrieval results based on the selection data. The operations can further include processing the query and the updated set of retrieval results with a sequence processing model to generate a model output from the sequence processing model.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 depicts a block diagram of a system for refining ambiguous queries in accordance with example embodiments of the present disclosure;

FIG. 2 depicts a block diagram of a clustering system in accordance with example embodiments of the present disclosure;

FIG. 3 depicts a flow diagram in accordance with example embodiments of the present disclosure;

FIG. 4 depicts a block diagram of an example computing system 400 for refining ambiguous queries according to example embodiments of the present disclosure;

FIG. 5 depicts an example client-server environment 500 according to example embodiments of the present disclosure;

FIG. 6 is a flow diagram representing a process for refining ambiguous queries in accordance with example embodiments of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

### DETAILED DESCRIPTION

Certain existing machine learning models (e.g. large language models, large multimodal models, etc.) have the ability to respond to user queries with a model-generated response. One method for improving the accuracy or groundedness of the model-generated response is to provide additional contextual data as input to the machine-learned model alongside the input query. This additional contextual data can enable a machine-learned model to provide more accurate and relevant responses. A prominent group of techniques for retrieving the additional contextual data is referred to as “retrieval-augmented generation” or RAG. However, in some instances, a submitted query can be ambiguous, or it may otherwise be difficult even for robust RAG systems to identify the appropriate contextual information to retrieve and provide as additional context. In these cases it can be difficult to provide the additional contextual data without including data that is not, in fact, relevant. The inclusion of irrelevant contextual data may reduce the accuracy or groundedness of the model-generated output.

In view of this challenge, the present disclosure is directed to a system for refining the supplemental contextual information retrieved for ambiguous input queries. In particular, an example query response system can receive an input query. For example, the input query can be received from or otherwise specified by a user. The query response system can access supplemental information from a knowledge base for the input query. The supplemental information can be embedded documents that can be used as context when generating a response to the input query. However, some queries are ambiguous, such that a variety of different topics may be associated with the input query. If the input query is ambiguous, some of the supplemental information retrieved can be non-relevant to the input query. Thus, once an input query is received, the query response system can access a plurality of retrieval results from the knowledge database. The query response system can calculate a diversity score for the retrieval results. The diversity score can be a representation of the variety of topics included in the retrieval results. If the diversity score exceeds a threshold value, the search response system can generate a plurality of retrieval result clusters from the plurality of retrieval results.

The query response system can obtain a representative item from each retrieval cluster in the plurality of retrieval result clusters. In some examples, the representative item can be selected from the content included in the retrieval results. A representative item can be an image from one of the retrieval results, a label associated with the retrieval result cluster, or a combination of both. For example, if there are four major retrieval result clusters, the query response system can select an image and/or a label for each of the four major retrieval result clusters.

In other examples, the representative times can be generated by a generative machine-learned model. For example, one or more retrieval results from a particular retrieval result clusters can be provided as input to a generative model. The generative model can generate a representative item for the retrieval result cluster that includes images and/or text describing the retrieval result cluster. In other examples, the query response system can access representative items from a database of predetermined representative items. For example, the centroid embedding for the retrieval result cluster can be matched to the closest embedding in a database of embedding/representative items pairs. In some examples, the system can generate a semantic label for the retrieval result cluster and the semantic label can be used to retrieve a relevant representative item.

The query response system can transmit the representative items to the user computing device from which the input query rows are received along with a request to clarify which of the clusters the user is interested in. The user can provide feedback. The feedback can include the user selecting one or more of the representative items using an input device (e.g., a mouse, a touch screen, etc.). In some examples, the user can provide selection data based on audio input (e.g., the user can say the name of one or more representative items). The system can provide eye tracking or gesture recognition to determine user selection of a representative items.

In some examples, the Once the query response system has received feedback, the query response system can filter the query results based on the feedback. For example, if the user selects one of the retrieval result clusters, the query results would be filtered to remove the query results from every cluster other than the selected cluster. In other examples, the query response system can generate an updated set of retrieval results based on the feedback received. Once the retrieval results have been filtered or updated, the query response system can generate input for a machine-learned model. The input can include the input query, the retrieval results for context, and any other information needed in the prompt. The prompt can be provided to a machine learning model, and the machine learning model can generate a model response. The model response can be returned to the user computing device for display.

For example, if the user submits a query that reads “tell me about Washington,” the query response system can generate a plurality of retrieval results based on the term Washington. However, it may be ambiguous as to whether the user is referring to George Washington (a famous historical person), the state Washington (a state in the United States of America), or Washington DC (the capital city of the United States of America). As a result, the diversity score associated with the retrieval results can exceed a diversity score threshold. As a result, the query response system can generate a plurality of retrieval result clusters for the retrieval results. In this example, the retrieval result clusters can identify three primary clusters, each retrieval result cluster associated with one of the options described above. The query response system can generate representative items for each retrieval result cluster, including an image and a label, and transmit them to the user computing device. The user computing device can display the three representative items to the user. The user can select one or more representative items. If the user selects George Washington (e.g., the famous historical person), the query response system can either filter the retrieval results to remove retrieval results not related to the selected person or generate a rewritten search query that focuses on George Washington, the person and retrieves a new set of retrieval results. Once the retrieval results have been refined, the query response system can generate an input prompt as input to a machine learning model. The input prompt can include the input query, the set of retrieval results associated with George Washington, and any other contextual information about the user or the query generated by the query response system. The sequence processing model can take the input prompt as input and generate a model output that includes a response to the input query. This model output can be transmitted to the user computing device for display to the user.

More particularly, a query response system can provide responses to input queries submitted via a computer network. In some examples, the responses can include a natural language response to the input query. Once the query response system has received the input query, the query response system can retrieve a plurality of retrieval results associated with the input query. The retrieval results can provide context for the input query for a machine-learned model that generates the response. The retrieval results can be retrieved from a knowledge database. In some examples, the retrieval results can be stored in the knowledge data as precomputed embeddings.

If the query is determined to be ambiguous, the resulting retrieval results may not provide context for the correct topic. As a result, when the retrieval results are received, the current response system can generate a diversity score for the plurality of retrieval results. The diversity score can represent the amount of diversity in the retrieval results. For example, a query that is potentially associated with two or more topics will have a higher diversity score than an input query that is primarily associated with a single topic. To determine a diversity score for a set of retrieval results, the query response system can calculate a centroid of the embeddings and an average distance from each retrieval result to the centroid. The larger average distance can correspond to a higher diversity. Other methods, such as computing the average distance between pairs of embeddings or a generalized variance, can be used.

In some examples, the calculation of the diversity score can include a centroid-based method where the centroid of a cluster is determined using the average position of all points (or embedded documents) within that cluster. The distance metric employed can vary based on the characteristics of the data, for example incorporating Euclidean or Manhattan distances. These metrics can facilitate the computation of distances between each point and the centroid, which are then aggregated to yield a final diversity score. This score quantitatively represents the spread or variability within the cluster, providing a metric for subsequent processing steps such as clustering validation and thresholding.

In some examples, the diversity threshold value can be tuned to allow queries without significant ambiguity to meet the diversity threshold and bypass the system for refining the retrieval results. In contrast, queries with high ambiguity do not meet the threshold and the system for refining the retrieval results can be used. In this way, the additional cost of refining the retrieval results for ambiguous queries is only used in specific circumstances. Doing so reduces the total cost while maintaining the system's advantage for significantly ambiguous queries.

In some examples, once the query response system determines that the query is ambiguous (e.g., based on the high diversity score for the retrieval results retrieved from the knowledge database), the query response system can cluster the retrieval results into a plurality of clusters. This can be done by a variety of different clustering algorithms. Ideally, the clustering algorithm should be robust against outliers because at least some retrieval results in the set of retrieval results will not cleanly fit into an existing cluster. Clustering algorithms can include a k-medoids clustering mechanism, a Gaussian mixture model with regularization, or other similar clustering algorithms.

In some examples, a number of clusters can be output by the clustering algorithm. In other examples, a simple heuristic order can determine the number of clusters (e.g., based on the diversity score or other heuristics). In other examples, the query search system predetermines the number of clusters or provides an upper limit to the number of clusters. In this way, the total number of clusters can remain within reasonable limits.

Once a plurality of clusters have been generated, the query response system can select, for each cluster, a representative item. In some examples, the retrieval results can have different types of content. The retrieval results can be multimodal. The types of content can include textual content, image content, video content, interactive content and so on. A specific retrieval result may include two or more of these types of contents.

In some examples, the retrieval results can include a plurality of documents. One of the documents, or a portion of one of the documents, can be selected as the representative item. In other examples, the query response system can determine one or more topics associated with a particular cluster and access materials associated with that topic. For example, the query response system can select an image and a label for each cluster from the plurality of retrieval results. For example, if the search is for Georgia, the search query system may generate two clusters, one for the country of Georgia and one for the state of Georgia. For each cluster, the query response system can select a representative image and a label indicative of this specific location.

Once the query response system selects a representative item for each of the identified clusters, the query response system can transmit the representative items to a user computing device for display. In the interface associated with the query response system, the user computing device can display the selected representative items and prompt the user to provide feedback information to help clarify the query. Feedback information can include a user selecting one or more representative items based on the particular topic the user is interested in. If the user selects none of the representative items, the system can prompt the user to provide additional information to the query to reduce its ambiguity.

Feedback information indicates interest in one or more of the representative items, and the query response system can use this information to refine the plurality of retrieval results. For example, the query response system can discard the retrieval results for any cluster not selected by the user. In other examples, the query response system can rewrite the query to generate an additional set of query results. The rewritten query can include information from the user selections and generate a new search for the retrieval results. In some examples, the query response system can train a machine learning model to determine which retrieval results from the set of retrieval results are relevant based on the selection data.

Once the set of user results has been revised based on the selection data, the query response system can generate an input to a machine learning model. Input can be a prompt, which can include the input query, an updated set of user results, and the other contextual information relevant to generating a query response. The machine learning model can be a sequence processing model that takes a prompt as input and generates a national language response as model output. In some examples, once the sequence processing model has received the prompt as input, it can generate a model output. The model output can include a natural language response to the query. In some examples, the model output can be a multimodal response and include text and one or more media elements.

In some examples, one or more machine learning models can be trained to select representative items by generating a training data set. The training data set can be generated by asking users to interact with the query response system. The user can generate a query, the query response system can proceed through the process up until the point that representative items are selected. The users can then rate the representative items. In another example, a plurality of representative items can be generated for a particular cluster and the users can select which representative item is the best representative item. The data generated by users providing feedback on selected representative items can be used to train a model that selects representative items given a set of retrieval results.

Systems and methods according to some aspects of the present disclosure can provide a variety of technical effects and benefits. For example, in some instances, systems and methods according to some aspects of the present disclosure can generate higher quality (e.g., more accurate, more useful, more relevant, more grounded, etc.) inference outputs compared to some alternative implementations.

As another example, in some instances, systems and methods according to some aspects of the present disclosure can generate inference outputs at a reduced computational cost compared to some alternative implementations. As one example, in cases which include semantically ambiguous queries, traditional systems may result in one or more model-generated responses that do not address the query or otherwise contain irrelevant information. This can result in the submission of multiple queries, with each query incurring the computational costs of model inference for response generation. In contrast, the proposed techniques can clarify ambiguous queries prior to or as a stage of model processing. This can result in the first model-generated response being more relevant, accurate, or grounded. As such, the number of query-response cycles can be reduced, thereby resulting in reduced consumption of computational resources such as processor cycles, memory usage, network bandwidth, etc.

Additionally, in some instances, systems and methods according to some aspects of the present disclosure can generate similar-quality inference outputs at a reduced computational cost compared to some alternative implementations, for example by increasing the relevancy of the supplemental contextual data provided to the model. Specifically, by providing more relevant data (e.g., as compared to multiple clusters of data which include both relevant and non-relevant data), the proposed approach can enable a smaller model to generate a similar similar-quality inference outputs to a relatively larger model which is provided with both relevant and non-relevant data. For example, in some instances, the quality of an inference output can scale with a computational complexity (e.g., parameter count, context window size, computational cost of inference, etc.) of a machine-learned model. In some instances, methods that can enable higher-quality outputs using a similar-complexity (e.g., same parameter count, same context window size, same computational cost, etc.) machine-learned model can be adapted to generate similar-quality outputs using a reduced-computational-cost (e.g., reduced parameter count, reduced context window size, reduced electricity cost of inference, reduced memory footprint, reduced processor usage, etc.) machine-learned model, thereby improving the functioning of a computing system comprising the machine-learned model by enabling similar (e.g., same) functionality at a reduced computational cost compared to some alternative implementations.

Various example implementations are described herein with respect to the accompanying Figures.

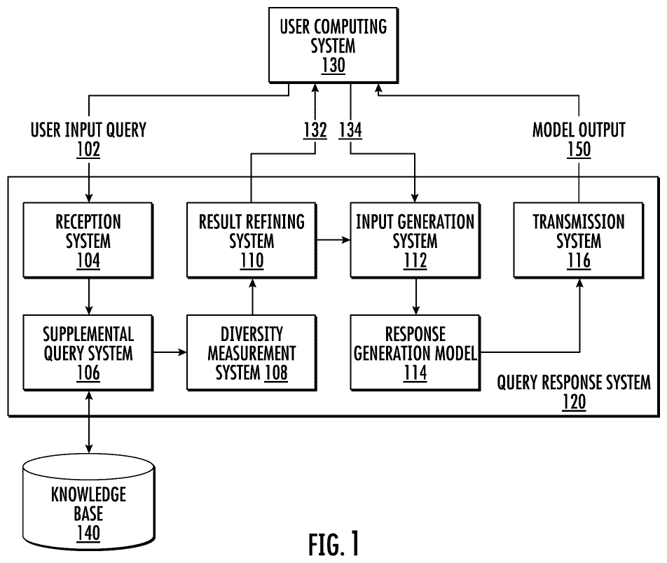

FIG. 1 depicts a block diagram of a system for refining ambiguous queries in accordance with example embodiments of the present disclosure. A user computing system 130 can transmit an input query 102 to a query response system 120. The input query 102 can include text provided by a user via an application on the user computing system 130. In some examples, the input query 102 can be multimodal. A multimodal input query can include one or more of: text content, audio content, image content, and video content.

In some examples, reception system 104 can receive the input query 102 and provide initial processing of the content included in the input query 102. In some examples, the reception system 104 can implement an application programming interface (API) that enables the system to receive the input query 102. The reception system 104 can provide the input query 102 to a supplemental query system 106.

A supplemental query system 106 can retrieve additional information useful to a machine-learned model for generating a model response to the input query 102. For example, a knowledge base 140 can include a significant amount of detailed information about particular topics. This information can include information that is not readily accessible to the machine-learned model. Thus, to improve the accuracy of the output of the machine-learned model, a supplemental query system 106 can generate a query to retrieve additional information from the knowledge base 140.

The supplemental query system 106 can enable the query response system 120 to retrieve supplemental data from the knowledge base 140. Generating a response using supplemental data can be referred to as retrieval augmented generation (RAG). The supplemental query system 106 can generate one or more queries based on the input query 102 and provide it to a knowledge base 140. The knowledge base 140 can identify a set of results based on the supplemental query. The knowledge base 140 can provide the set of results to the supplemental query system 106.

In some examples, the results from the knowledge base 140 can be formatted as embeddings. Each embedding can represent a particular document embedded into a particular embedding space. The list of retrieved results can be provided to a diversity measurement system 108. The diversity analysis system can determine the amount of diversity in the set of retrieved results. There can be a variety of techniques for measuring the diversity of the results.

In some examples, the query response system 120 can measure the diversity of results by calculating a centroid for all the embeddings in the retrieved results. Once the centroid is determined, the diversity measurement system 108 can calculate the average distance from each result to that centroid. The larger the average distance, the higher the diversity. In other examples, the diversity measurement system 108 can sample a variety of pairs of embeddings and compute the average distance between those pairs. The number of pairs that are analyzed can be increased or reduced to shorten or lengthen the amount of time needed to generate an estimate. In some examples, the diversity measurement system 108 can compute general variance using a covariance matrix.

The diversity measurement system 108 can compare a measured diversity from the list of results to a predetermined diversity threshold. In some examples, if the measured diversity value exceeds the predetermined diversity threshold, the diversity measurement system 108 can determine that the list of results is ambiguous and needs to be analyzed to reduce the number of results. In some examples, the predetermined threshold value can be tuned through training to determine the optimal threshold value. In other examples, the threshold value can be determined based on user preference. For example, a user may have previously indicated a preference for accuracy over speed. If so, the diversity threshold may be lower. Alternatively, a user can show a preference for speed over accuracy. In that case, the diversity threshold can be raised, which results in fewer queries determined to be ambiguous.

In accordance with a determination that the diversity value associated with the set of retrieved results exceeds the predominant threshold, the diversity measurement system 108 can provide the list of results to the user feedback system. The user feedback system can cluster the results into two or more clusters. A variety of methods can be used to cluster the set of retrieved results. In some examples, once the retrieved results have been clustered, the result refining system 110 can identify a representative item from each particular cluster. The representative item can include text and/or images in some examples. For example, if the input query is “tell me more about Washington,” the result refining system 110 can group the search results into three clusters. A first group may be associated with George Washington, the person; a second group may be related to Washington DC, the city; and a third group may be associated with Washington state.

The result refining system 110 can transmit the representative item from each group to the user computing system 130. For example, the representative items can be displayed in the user interface of an application along with the prompt requesting that the user select any representative items that match one or more subjects the user is interested in. The user can then select any of the representative items the user wishes. In some examples, the user will not choose any representative items. This can indicate that none of the proposed clusters are associated with the user's intended topic. In this case, additional follow-up questions may be needed to determine the user's interests.

The users can select a particular identifying item and transmit that data to the result refining system 110. The input generation system 112 can filter the results based on the user selection. In some examples, the set of retrieved results can be filtered so that only the results associated with the selected clusters remain. In other examples, the supplemental query system 106 can update the supplemental query and run a new search from the knowledge base 140. In this way, the set of results can only include documents relevant to the clusters selected or indicated by the user via the user computing system 130.

The updated set of retrieved results can be provided to the input generation system 112. The input generation system 112 can generate an input to response generation model 114. Input can be a prompt that includes the text of the input query 102, the set of results that include supplemental information, and any other contextual information needed to generate the factory output.

Once the input generation system 112 has generated model input, the model input can be transmitted to the response generation model 114. The response generation model 114 can be a machine-learned model that has been trained to generate an output based on an input prompt. The model output can be a text response to the input query 102. In some examples, the response generation model is a generative model, a sequence processing model, or another type of large language model.

The response generation model 114 can generate a model output and provide it to the transmission system 116. The transmission system 116 can transmit the model output 150 to the user computing system 130.

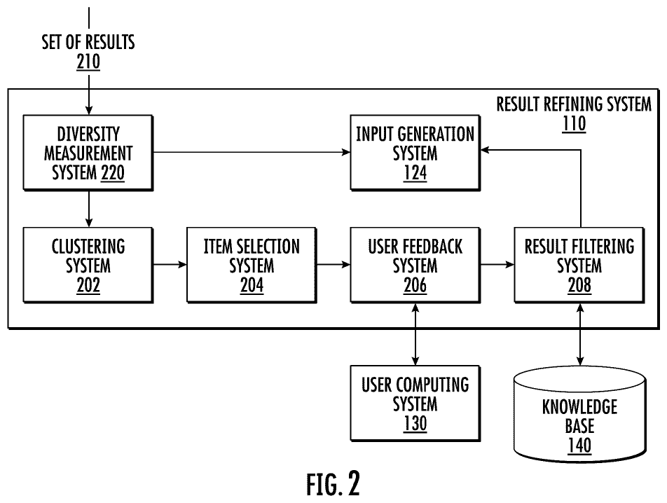

FIG. 2 depicts an example result refining system 110 in accordance with the example embodiments of the present disclosure. In some examples, the result refining system 110 is part of a query response system 120, as seen in FIG. 1. The result refining system 110 can include a diversity measurement system 220, the clustering system 202, an item selection system 204, our user feedback system 206, a result filtering system 208, and an input generation system 124.

The diversity measurement system 220 can receive a set of retrieved results. The retrieved results can be formatted as embeddings. An embedding can be a representation of the document formatted within a particular embedding space. The diversity measurement system 220 can generate a diversity score for the list of retrieved results. The diversity measurement system 220 can use one of a plurality of different options to measure the diversity within the set of retrieved results. One option for calculating this diversity score can include computing a centroid within the embedding space for the plurality of retrieving results. Specifically, suppose all of the retrieved results are represented as embeddings within a particular embedding space. In that case, the diversity measurement system 220 can compute a centroid of the embeddings within the embedding space. The diversity measurement system 220 can determine the distance from the embedding associated with each retrieved result in the set of retrieved results to the calculated centroid. The average of these distances can be used as the diversity score. The larger the average distance, the higher the diversity of the set of retrieved results.

In another example, the diversity measurement system 220 can determine a plurality of pairs of embeddings within the retrieved results. For each determined pair of embeddings, the diversity measurement system 220 can determine a different distance between these pairs. The diversity measurement system 220 can determine the average distance between the pairs of embeddings. In some examples, the diversity measurement system 220 can reduce the time needed by reducing the number of determined pairs. The diversity measurement system 220 can increase the accuracy of the average by increasing the number of determined embedding pairs.

In another example, the diversity measurement system 220 can compute a generalized variance for the set of retrieved results. For example, the diversity measurement system 220 can compute a covariance matrix for the set of retrieved results (based on their embeddings). The diversity measurement system 220 can then calculate a determinant of that covariance matrix. This determinant can be used to measure the spread of the variance and represent the diversity of the set of retrieved results.

The diversity measurement system 220 can determine whether the generated diversity score exceeds a predetermined threshold. As noted above, the predetermined threshold can be tuned based on the needs of a particular user or a particular system. If the diversity threshold is increased, the likelihood that the diversity measurement system 220 determines that the set of retrieved results is ambiguous (e.g., contains results associated with more than one topic) is reduced. If the diversity threshold is lowered, the likelihood that the diversity measurement system 220 will determine that the set of search results is ambiguous is increased.

If diversity measurement system 220 determines that the diversity score for a set of search results exceeds the predetermined diversity threshold, the diversity measurement system 220 can provide the set of search retrieve results through the clustering system 202. If the set of retrieved results does not exceed the determined diversity threshold, the diversity measurement system 220 can provide the set of results to the input generation system 124.

The clustering system 202 can analyze the retrieved results to generate a plurality of clusters within the embeddings representative of the retrieved results. A variety of different algorithms or techniques can be used to cluster the embeddings. The selected algorithm should be robust against outliers so that not all retrieved results are cleanly grouped into a cluster. Example methods can include a k-medoids method. The k-medoids method is similar to a K-means method but where the centroid is not the mean but the medoid (a generalization of the median).

In other examples, the method can use a Gaussian mixture model with regularization. The regularization can ensure that individual elements do not overly influence the cluster. In some examples, the clustering algorithm can determine the number of clusters. In other examples, the number of clusters can be predetermined when the result refining system 110 is trained. For instance, clustering system 202 can be trained so that the number of clusters generated is between 2 and 4. This may be preferable so as not to overwhelm the user with too many options. In some examples, a simple heuristic can be used to determine the number of clusters.

Once the number of clusters has been determined by the clustering system 202, the cluster information can be transmitted to item selection system 204. The item selection system 204 can determine a representative item for each cluster in the plurality of clusters. In some examples, the representative item can be determined based on the embedded document most near the center of the cluster or the cluster medoid. In other examples, the item selection system 204 can sample a small number of elements from the cluster. These samples can be analyzed, and the item selection system 204 can select the item that best represents the cluster. In some examples, the sub-sample of selected items can be provided to a machine-learned model, which can select or generate a representative item. For example, the representative item can be an image or a short piece of text representing the general idea of the cluster. In other examples, an image can be selected, and the item selection system 204 can generate a word or phrase representing the image.

In some examples, the representative items can be provided to a user feedback system 206. In some examples, the user feedback system can generate a summary for each cluster or for the set of retrieved results. For example, the summary can explain the topics associated with each cluster in the plurality of clusters. In some examples, the summary step can be skipped for efficiency.

The user feedback system 206 can generate a request for user feedback. The request for user feedback can be an interactive document that includes the representative items for each cluster and the generated summary. The request can be transmitted to the user computing system 130 and displayed to the user.

In some examples, interactive documents are displayed to the user in a format in which the user can provide feedback, such as selecting one, multiple, or none of the representative items. If the user selects none of the representative items, the user feedback system 206 can prompt the user to provide additional clarification for their query. If the user has selected one or more of the representative items, the user feedback system 206 can provide that feedback to the result filtering system 208. In some examples, the user can negatively indicate one or more of the representative items. A negative indication can represent that the user is not interested in the information associated with that particular cluster.

Once the result filtering system 208 has received feedback from the user, the result filtering system 208 can update this set of retrieved results. For example, the result filtering system 208 can remove any result or embedding associated with a cluster that the user did not select or associated with a cluster that the user negatively indicated. In this way, all results remaining in the set of results 210 can be associated with topics that the user has selected. In some examples, the result filtering system 208 can generate a new query based on the user feedback. This new query can be transmitted to the knowledge base 140, and the knowledge base 140 can provide an updated set of retrieved results. In some examples, the updated set of results can be analyzed again using the same process.

Once the set of results has been updated, the result filtering system 208 can provide the set of results to the input generation system 124. The input generation system 124 can generate input for a machine-learned model. The input to the machine-learned model can be a prompt that includes the input query 102, the set of results 210, and any contextual information needed to provide an adequate model output. The model in the book can then be transmitted to the response generation model.

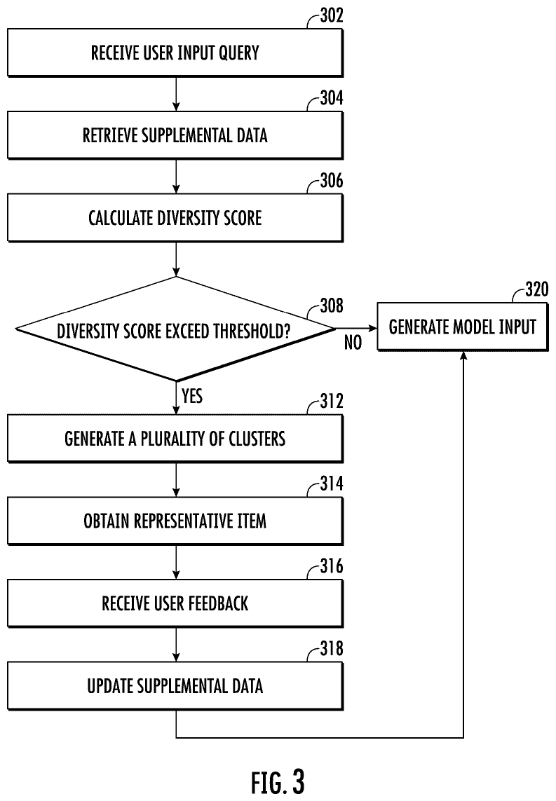

FIG. 3 is a flow diagram representing a method for refining ambiguous retrieval-augmented generation queries through user feedback in accordance with an example embodiment of the present disclosure. In this example, the response generation system can, at 302. receive an input query. The input query can be multimodal, including both text content and image, video, and audio content. The input query can be a question submitted in plain language.

Once the input query has been received, the response generation system can, at 304, retrieve supplemental data associated with the input query. Supplemental data can include accessing the knowledge base and performing the search to retrieve results that provide additional information about the content and the subject of the input query. In some examples, the results can be retrieved as embedded data. Embedded data can represent the contents of a document that has been encoded into an embedding space. The knowledge base can return a set of retrieved results, each of which is an embedded document.

Once the response generation system has received a set of retrieved results, the response generation system can, at 306, calculate a diversity score for the set of retrieved results. The diversity score can represent the degree to which the retrieved results cover different topics. As discussed above, diversity of the retrieved results can be measured using a priority of different algorithms. For example, the system can determine an average distance from the center of the embeddings, the average distance between different pairs of embeddings, or other means. The diversity measure can be represented as a diversity value for the set of retrieved results.

Once the diversity value has been determined, the response generation system can, at 308, determine whether the diversity score exceeds a predetermined diversity threshold.

The predetermined diversity threshold can be tuned to ensure that the threshold is only exceeded in cases where there is genuine ambiguity in the set of retrieved results.

If the diversity score does not exceed the predetermined diversity threshold, the response generation system can, at 320, generate a model input based on the initial set of retrieved results. However, if the diversity score does exceed the predetermined diversity threshold, the response generation system can process the retrieved results to, at 312, generate a plurality of clusters among the retrieved results. Each cluster can represent a different topic in the retrieved results. As discussed above, a plurality of different methods or algorithms can generate these clusters.

Once the search results have been analyzed to generate a plurality of clusters, the response generation system can, at 314, select a representative item from each cluster. In some examples, the response generation system can select a representative item based on the most central embedding of the embeddings in a particular cluster of embeddings. In some examples, the plurality of embeddings in a specific cluster can be sampled and analyzed to determine a representative item. The representative item can be text, image, video, or a multimodal representative that includes two or more data types.

Once the response generation system has selected a representative item for each cluster, those representative items can be included in an interactive web page or document and transmitted to a user. This formatted web page (or other document) can be displayed to the user and enable the user to select one or more of the representative items. The user can select one item, multiple items, or no items. If the user selects no items, the query response system can ask the user to provide additional information to refine the input query. In some examples, the user can mark particular items as not relevant rather than marking particular items as relevant. The query response system can, at 316, receive user feedback.

Once the query response system has received user feedback, the response direction system can, at 318, update the supplemental data. Updating the supplemental data can include filtering out the embeddings with clusters that are not relevant to the input query. In addition, the response generation system can, at 320, generate an additional query to retrieve new embeddings from the knowledge base. Once the supplemental set of results has been updated, the response generation system can create a model input using that updated supplemental data.

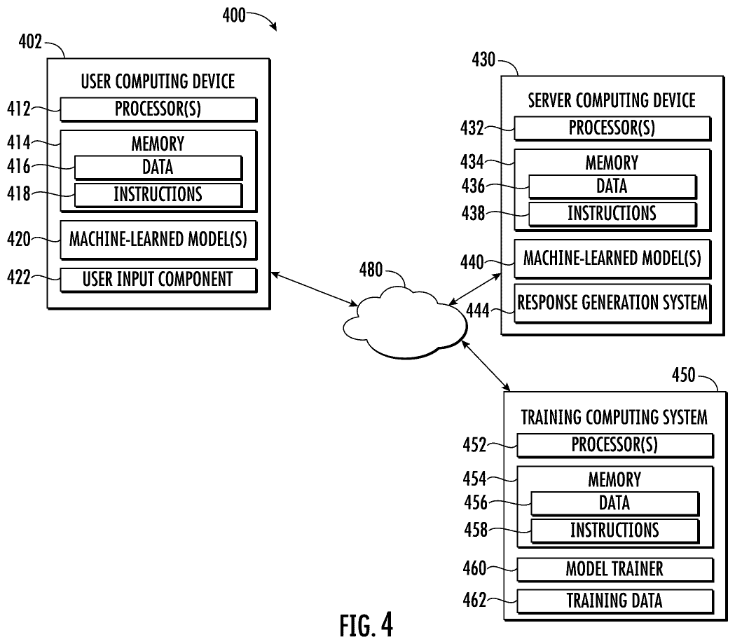

FIG. 4 depicts a block diagram of an example user computing system 400 for refining ambiguous queries according to example embodiments of the present disclosure. The computing system 400 includes a user computing device 402, a server computing system 430, and a training computing system 450 that are communicatively coupled over a network 480.

The user computing device 402 can be any type of computing device, such as a personal computing device (e.g., laptop or desktop), a mobile computing device (e.g., smartphone or tablet), a gaming console or controller, a wearable computing device, an embedded computing device, or any other type of computing device.

The user computing device 402 includes one or more processors 412 and a memory 414. The one or more processors 412 can be any suitable processing device (e.g., a processor core, a microprocessor, an ASIC, an FPGA, a controller, a microcontroller, etc.) and can be one processor or a plurality of processors that are operatively connected. The memory 414 can include one or more non-transitory computer-readable storage mediums, such as RAM, ROM, EEPROM, EPROM, flash memory devices, magnetic disks, etc., and combinations thereof. The memory 414 can store data 416 and instructions 418, which are executed by the processor 412 to cause the user computing device 402 to perform operations.

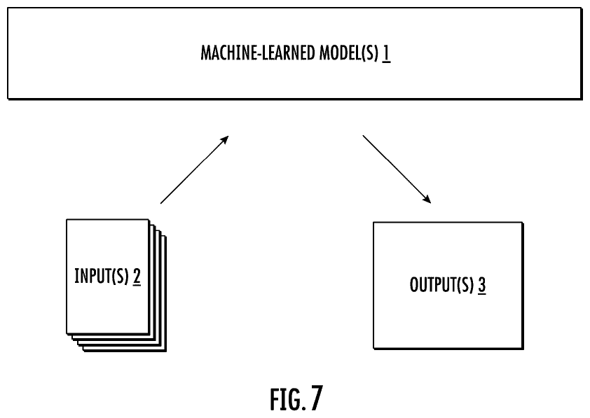

In some implementations, the user computing device 402 can store or include one or more machine-learned models 420 (e.g., a sequence processing model or another generative model). For example, the machine-learned models 420 can or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 420 are discussed with reference to FIGS. 7-11.

In some implementations, the one or more machine-learned models 420 can be received from a server computing system 430 over network 480, stored in the memory 414 of the user computing device 402, and then used or otherwise implemented by the one or more processors 412. In some implementations, the user computing device 402 can implement multiple parallel instances of a single machine-learned model 420.

More particularly, the machine-learned model 420 (e.g., a sequence processing model) can respond to user input queries received from a user. To do so, a query response system can access a knowledge base (e.g., a database of documents that includes information useful when responding to user input queries.). In some examples, the knowledge base is stored remotely from the user computing device 402. In this case, the user computing device can transmit queries to and receive responses from the knowledge base via a communication network 480.

The query response system can receive a list of results from the knowledge base. The results can be search results. In some examples, the list of results is formatted as a set of document embeddings. Each embedding can represent a particular document and its contents. The embeddings can represent the contents of the document in a particular embedding space.

The set of retrieved results can be analyzed to determine whether the results cover more than one general topic. If the results cover more than one general topic, then the set of results may introduce ambiguity when responding to the input query. Thus, it would be helpful to remove any retrieved result that is not associated with the topic in which the user is interested. Thus, to determine whether the set of retrieved results covers more than one general topic, the system can calculate a diversity score or value for the set of retrieved results.

Calculating the diversity score of the set of results can be performed using a variety of methods. For example, the system can determine a centroid for the embeddings and calculate the average distance from each embedding to the centroid. In another example, the system can determine a series of distances between a plurality of pairs of embeddings. The query response system can determine the average distance between embeddings. This measure can be made more accurate by performing more measurements between pairs and meetings, and the measure can be made more quickly by reducing the number of pairs. In another example, the query response system can determine a covariance matrix for the set of retrieved embeddings and determine the determinant of that matrix.

The measured diversity score can then be compared against the threshold. If the diversity score exceeds the threshold, the system can determine that the retrieved embeddings represent more than one topic, and that ambiguity may exist in the set of results. Based on this determination, the query response system can analyze the results to determine a plurality of clusters or embeddings within the retrieved results. The clusters should represent distinct topics within the embedding set.

Different algorithms, as described above, can be used to determine the plurality of clusters. In some examples, the query response system can determine the number of clusters beforehand to avoid the clusters exceeding a predetermined threshold of number of clusters. In some examples, the system can use simple heuristics to determine the number of clusters. In another example, the number of clusters can be determined based solely on the algorithm used to cluster the retrieved results.

Once the system determines a priority of clusters within the set of retrieved results, the system can identify a representative item for each cluster in the plurality of clusters. A representative item can be an item that allows the user to understand the topic for which the cluster is associated. The representative item can be a title or a phrase that describes the cluster, an image or video that can help the user understand the cluster comments, or a combination of text and media. In some examples, a machine-learned model can determine the representative item from the set of retrieved embeddings. The machine-learned model can take one or more results as input and output a representative item.

The query response system can provide each representative item to the user. The user can select one, multiple, or none of the representative items. In some examples, the user can mark particular representative items as not relevant. Once the user has provided feedback, the system can update the set of retrieved results based on the user's actions. For example, when one or more representative items are selected, the retrieved results for other clusters can be removed from the set of retrieved results. If the user selects none of the representative items, the query response system can ask the user to update the input query.

Once the set of retrieved results has been updated, the query response system could generate a model input, including the input query, the updated results, and any additional contextual information that could enable the response model to provide a better output. The model input can be provided to the machine-learned model, and the machine-learned model can output a response to the input query. The response can be displayed to the user.

In some examples, the model output can include citation information that describes the source of each piece of information included in the model output. For example, citation information can be provided in the input to the model, where citation information is used to describe a source that the user can use to verify information included in the model output. For example, the citation information can be a web page from which the passage was derived.

The user computing device 402 can also include one or more user input components 422 that receive user input. For example, the user input component 422 can be a touch-sensitive component (e.g., a touch-sensitive display screen or a touchpad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage mediums, such as RAM, ROM, EEPROM, EPROM, flash memory devices, magnetic disks, etc., and combinations thereof. The memory 434 can store data 436 and instructions 438, which are executed by the processor 432 to cause the server computing system 430 to perform operations.

In some implementations, the server computing system 430 includes or is otherwise implemented by one or more server computing devices. In instances in which server computing system 430 includes plural server computing devices, such server computing devices can operate according to sequential computing architectures, parallel computing architectures, or some combination thereof.

As described above, the server computing system 430 can store or otherwise include one or more machine-learned models 440 (e.g., a sequence processing model, a generative model, or other machine-learned models used by a query response system). For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 440 are discussed with reference to FIGS. 7-11.

The server computing system 430 also includes a response generation system 444. The response generation system 444 can receive a request from an application on the user computing device 402. In response, the response generation system 444 retrieves supplemental information, filters the supplemental information based on user feedback, and generates a prompt input based on the input query and the supplemental information. The response generation system 444 can then provide the input prompt and receive model output for the machine learning model(s) 440.

The user computing device 402 and/or a server computing system 430 can train the models 420 and/or 440 via interaction with the training computing system 450, which is communicatively coupled over the network 480. The training computing system 450 can be separate from or a portion of the server computing system 430.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage mediums, such as RAM, ROM, EEPROM, EPROM, flash memory devices, magnetic disks, etc., and combinations thereof. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that trains the machine-learned models 420 and/or 440 stored at the user computing device 402 and/or the server computing system 430 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to update the parameters over a number of training iterations iteratively.

In some implementations, performing backwards propagation of errors can include performing truncated backpropagation through time. The model trainer 460 can perform a number of generalization techniques (e.g., weight decays, dropouts, etc.) to improve the generalization capability of the models being trained.

In particular, the model trainer 460 can train the query response model and an item selection model based on a set of training data 462. The training data 462 can be generated by the interaction of raters with the query response system and the machine-learned model (e.g., a sequence processing model or other large language model). The raters can submit an input query. The query response system can access a set of results containing supplemental data from a knowledge base. If the set of results is determined to be ambiguous (based on a diversity score, the query response system can cluster the retrieved results into a plurality of clusters. The system can generate a plurality of options for the representative data for each cluster. The user can select the representative item that they like best for each cluster. The selection data can be used to train reward models. Similarly, training data for generating summaries can be generated by performing the above steps and generating them for generating the summaries. The raters can select their preferred summary and that data can be used to train reward models. Models for picking representative items and generating a summary can then be trained via Reinforcement Learning from Human Feedback (RLHF).

The model trainer 460 includes computer logic utilized to provide desired functionality. The model trainer 460 can be implemented in hardware, firmware, and/or software controlling a general-purpose processor. For example, in some implementations, the model trainer 460 includes program files stored on a storage device, loaded into a memory and executed by one or more processors. In other implementations, the model trainer 460 includes one or more sets of computer-executable instructions that are stored in a tangible computer-readable storage medium such as RAM hard disk or optical or magnetic media.

The network 480 can be any type of communications network, such as a local area network (e.g., intranet), wide area network (e.g., Internet), or some combination thereof and can include any number of wired or wireless links. In general, communication over the network 380 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can include audio data. The machine-learned model(s) can process the audio data to generate an output based on a request. As an example, the machine-learned model(s) can process the audio data and generate a response that includes audio data by extracting information from the audio data and updating or modifying it based on the request.

In some implementations, the input to the machine-learned model(s) of the present disclosure can be text or natural language data. The machine-learned model(s) can process the text or natural language data to generate an output. As an example, the machine-learned model(s) can process the natural language data to a particular multimodal input query and generate a prompt based on the multimodal input query.

As discussed above, the input to the machine-learned model(s) of the present disclosure can be speech data. The machine-learned model(s) can process the speech data to generate an output. As an example, the machine-learned model(s) can process the speech data to generate a speech recognition output. The output of the speech recognition system can be used as input to the image generation model.

For example, in some implementations, the user computing device 402 can include the model trainer 460 and the training data 462. In such implementations, the model(s) 420 can be trained and used locally at the user computing device 402. In some implementations, the user computing device 402 can implement the model trainer 460 to personalize the model(s) 420 based on user-specific data.

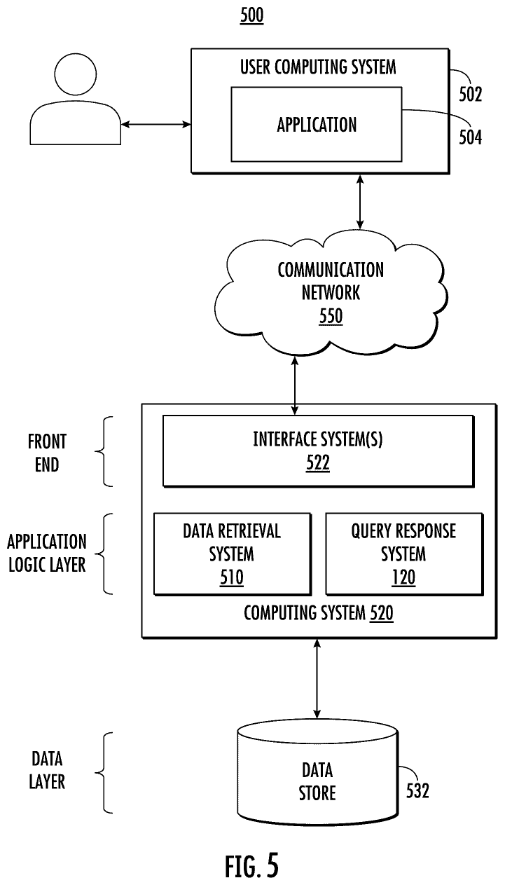

FIG. 5 depicts an example client-server environment 500 according to example embodiments of the present disclosure. The client-server system environment 500 includes one or more user computing systems 502 and a server computing system 520. One or more communication networks 550 can interconnect these components. The one or more communication networks 550 may be any of a variety of network types, including local area networks (LANs), wide area networks (WANs), wireless networks, wired networks, the Internet, personal area networks (PANs), or a combination of such networks.

A user computing system 502 can be one of, but is not limited to, a personal computing system, a smartphone, a smartwatch, a laptop computing device, and a tablet computing system. In some examples, the user computing system 502 can include one or more application(s) 504, such as search applications, communication applications, navigation applications, productivity applications, game applications, word processing applications, or any other applications. The application(s) can include a web browser that can access web-based services. The user computing system 502 can use the web browser application (or other applications) to send requests to and receive responses from the server computing system 520. The user computing system 502 can transmit a request to the server computing system 520. The request can be an input query. The server computing system 520 can retrieve supplemental data and generate a prompt for the sequence processing model. The prompt can be provided as input to the sequence processing model. The server computing system can return a model response to the user computing system 502.

As shown in FIG. 5, the server computing system 520 can generally be based on a three-tiered architecture, consisting of a front-end layer, application logic layer, and data layer. As is understood by skilled artisans in the relevant computer and Internet-related arts, each component shown in FIG. 5 can represent a set of executable software instructions and the corresponding hardware (e.g., memory and processor) for executing the instructions. To avoid unnecessary detail, various components and engines that are not germane to conveying an understanding of the various examples have been omitted from FIG. 5. However, a skilled artisan will readily recognize that various additional components, systems, and applications may be used with a user computing system 502, such as that illustrated in FIG. 5, to facilitate additional functionality that is not specifically described herein. Furthermore, the various components depicted in FIG. 5 may reside on a single server computer or may be distributed across several server computers in various arrangements. Moreover, although server computing system 520 is depicted in FIG. 5 as having a three-tiered architecture, the various examples of embodiments are not limited to this architecture.

As shown in FIG. 5, the front end can consist of an interface system(s) 522, which receives communications from one or more user computing system 502 and communicates appropriate responses to the user computing system 502. For example, the interface system(s) 522 may receive requests in the form of Hypertext Transfer Protocol (HTTP) requests, or other web-based application programming interface (API) requests. The user computing system 502 may be executing conventional web browser applications or applications developed for a specific platform to include any of a wide variety of computing devices and operating systems.

As shown in FIG. 5, the data layer can include a knowledge base 532. The knowledge base 532 can store data associated with responding to input queries. In some examples, the data can be stored as embeddings of a plurality of documents. In some examples, the knowledge base 532 can represent a plurality of distinct databases, each database storing a type of document. For example, the knowledge base 532 can include a plurality of documents, each indexed and/or embedded into an embedding space to allow for searchability or comparison to an input query. In some examples, the knowledge base 532 (or a database associated with the knowledge base 532) includes a plurality of embedded documents. Each embedded document can include information for a variety of topics. A search of the knowledge base 532 can identify relevant embedded documents and provide those embedded documents to the server computing system 520.

The application logic layer can include application data that provides a wide range of other applications and services, allowing users to submit queries and receive responses. The application logic layer can include a data retrieval system 510 and a query response system 120.

When a user computing system 502 transmits an input query to the server computing system 520, the data retrieval system 510 can access information from the knowledge base 532. The information can be supplemental to the input query. The supplemental information can be a plurality of embeddings representing one or more documents that have information relevant to the input query.

The data retrieval system 510 can determine whether the results in the set of retrieved documents are ambiguous. One method for determining whether they are ambiguous is to generate a diversity score for the retrieved set of results. The diversity score can be measured based on calculating a centroid for the embeddings within the embedding space and measuring the average distance from each embedding to the centroid. In other examples, the data retrieval system 510 can sample a variety of pairs of embeddings and determine the average distance between these pairs. Other methods may be used to determine a diversity score.

Once the system has determined a diversity score for the retrieved set of embeddings, the data retrieval system 510 can decide whether or not the diversity score exceeds a threshold. If the diversity score exceeds the threshold, the system can generate a plurality of clusters from the set of retrieved embeddings. The clusters can represent different topics within the set of retrieved embeddings. To determine which topics, if any, are relevant to the input query. The data retrieval system 510 can generate a representative item for each cluster. Representative items can include text, images, videos, or any combination that represents the particular cluster's topic.

The data retrieval system 510 can generate a description or summary of each cluster in some examples. Once the representative items or summaries have been generated, the data retrieval system can transmit a representative item or summary for each cluster in the priority of determined clusters to the user computing system 502. The user computing system 502 can display the representative item or summary of each cluster in the application 504 and request that the user provide feedback on which items or summaries are relevant to their input query. The user interface can allow the user to select one or more relevant representative items or summaries. In some examples, the user interface can enable the user to mark one or more representative items or summaries as non-relevant.

This information can be returned to the data retrieval system 510. The data retrieval system can remove non-relevant embeddings from the set of retrieved embeddings. For example, suppose a particular representative item is marked as relevant, and another representative item is not marked. In that case, the results associated with a non-marked cluster can be filtered from the set of retrieved results. The data retrieval system 510 can prompt the user for additional information if none of the items are selected.

The data retrieval system 510 can update the set of retrieved results based on the received information. In some examples, the data retrieval system 510 can request additional information from the knowledge base 532 based on the received User feedback.

Once the data retrieval system 510 has updated the set of retrieved results, the query response system 120 can generate input to a machine-learned model. The input can be a prompt that includes the input query, the updated set of results, and any other information relevant to the query (e.g., information about past user interactions with the model and so on).

The query response system 120 can generate an input prompt to the sequence processing model. The input prompt can include the multimodal input query, any rewritten portion of the query, any information retrieved through clarifying questions or search queries, and any relevant contextual information. The model input can be provided to the sequence processing model. The sequence processing model can generate a model output.

The model output can be transmitted to the user computing device for display. For example, the model output can include video and audio elements. The video content can be displayed on a screen, and a speaker can play the audio content. The audio content may include an explanation of the visuals depicted in the video content. In this way, the video content and the audio content can include different but related information for presentation to the user.

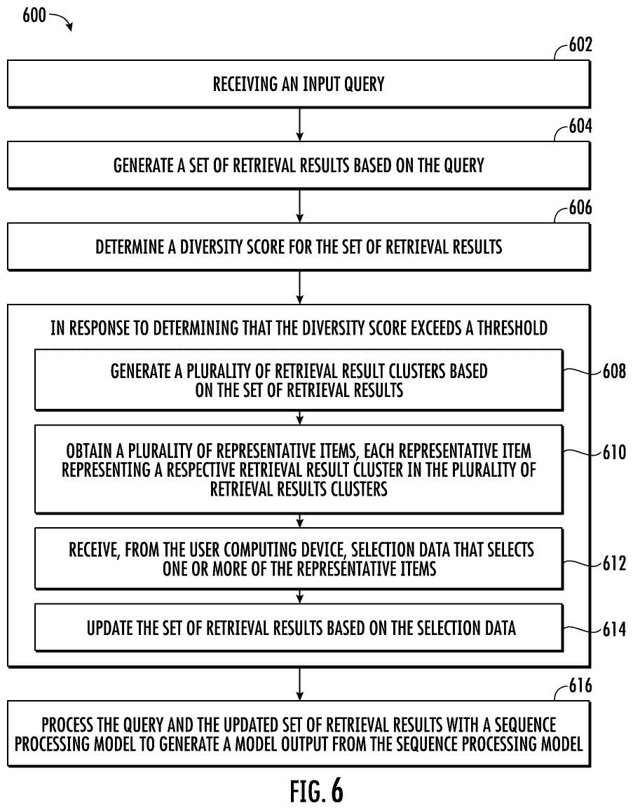

FIG. 6 depicts a flowchart of a method 600 for training one or more machine-learned models according to aspects of the present disclosure. For instance, an example machine-learned model can include a generative model capable of generating text output or image output. By way of example, generative models can include generative models associated with API endpoints (e.g., API endpoints), image generation models (e.g., image generation model 185), or generative models used for generating textual descriptions or style traits.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

In some examples, the query response system can, at 602, receive an input query. The query response system can, at 604, generate a set of retrieval results based on the query. In some examples, the retrieval results can comprise supplemental information provided as contextual information to the sequence processing model. In some examples, the retrieval results can comprise embedded documents retrieved from a knowledge base.

In some examples, the query response system can, at 606, determine a diversity score for the set of retrieval results. In some examples, the diversity score can be determined by calculating, by the computing system, a centroid of the embedded documents. In some examples, the query response system can determine the diversity score based on an average distance from each retrieval result to the centroid.

In some examples, the query response system can, at 608, in accordance with a determination that the diversity score for the set of retrieval results exceeds a threshold value, generate a plurality of retrieval result clusters based on the set of retrieval results. The threshold value can be a predetermined diversity threshold. In some examples, the number of retrieval result clusters in the plurality of retrieval result clusters is determined based on an analysis of the retrieval results. In other examples, the number of retrieval result clusters in the plurality of retrieval result clusters can be predetermined.

In some examples, the query response system can, at 610, select a plurality of representative items, each representative item representing a respective retrieval result cluster in the plurality of retrieval result clusters. In some examples the representative items for a respective retrieval result cluster comprise a labelled image extracted from a retrieval result included in the respective retrieval result cluster. The number of selected representative items can be a predetermined number. The number of selected representative items can be based on a number of retrieval result clusters in the plurality of retrieval result clusters and an importance of one or more retrieval result clusters in the plurality of retrieval result clusters.

In some examples, the query response system can, at 612, receive, from the user computing device, selection data that selects one or more of the representative items. The selection data can comprise data indicating a user selection of a specific representative item associated with a specific retrieval result cluster in the plurality of retrieval result clusters. In some examples, the selection data can comprise data indicating that the user did not select any of the representative items.

In some examples, the query response system can determine that the selection data does not include selection of any of the representative items. Responsive to determining that the selection data does not include selection of any of the representative items, the query response system can transmit a request for further clarification of the query to the user computing device.

In some examples, the query response system can, at 614, update the set of retrieval results based on the selection data. In some examples, the query response system can generate an updated set of retrieval results by filtering the set of retrieval results to remove retrieval results from retrieval result clusters not in the specific retrieval result cluster.

In some examples, updating the set of retrieval results based on the selection data further can include generating an updated input query based on the selection data. The query response system can generate an updated set of retrieval results based on the updated input query. In some examples, the query response system can, at 616, process the query and the updated set of retrieval results with a sequence processing model to generate a model output from the sequence processing model. The model output can be transmitted to the user computing device for display.

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of image generation model 185, etc. Although various features, variations, and implementations described below are described with respect to machine-learned model(s) 1, it is to be understood that such features, variations, and implementations are to be understood as described with respect to each of image generation model 185, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

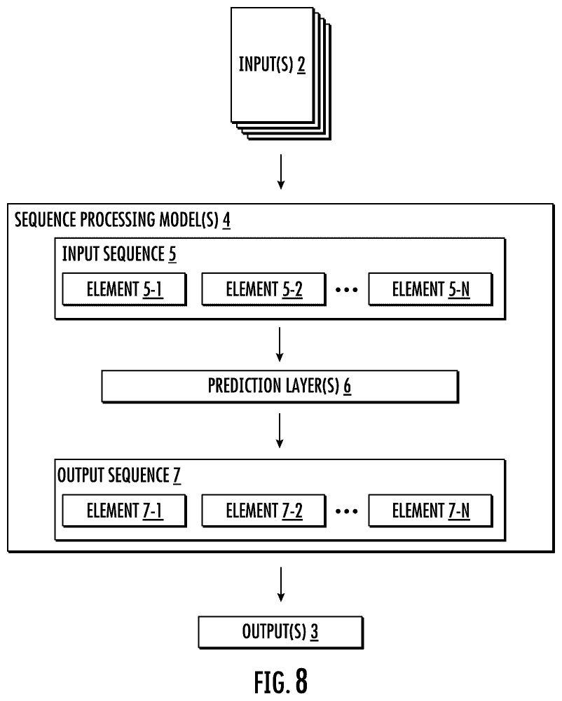

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

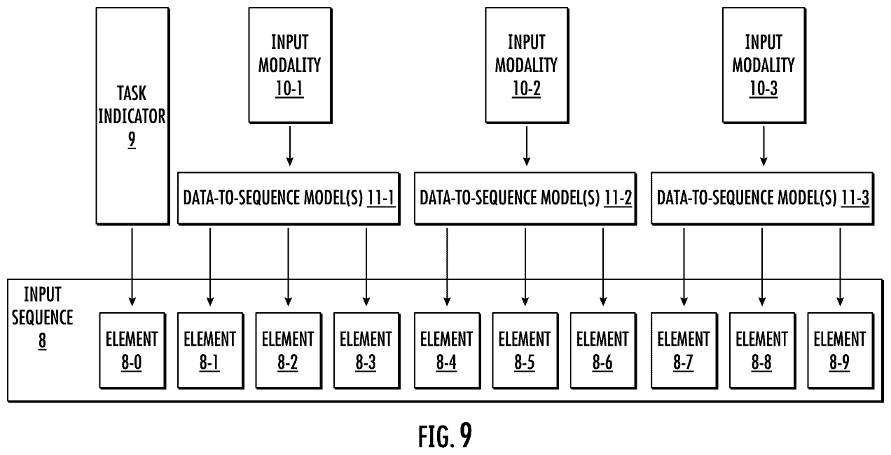

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

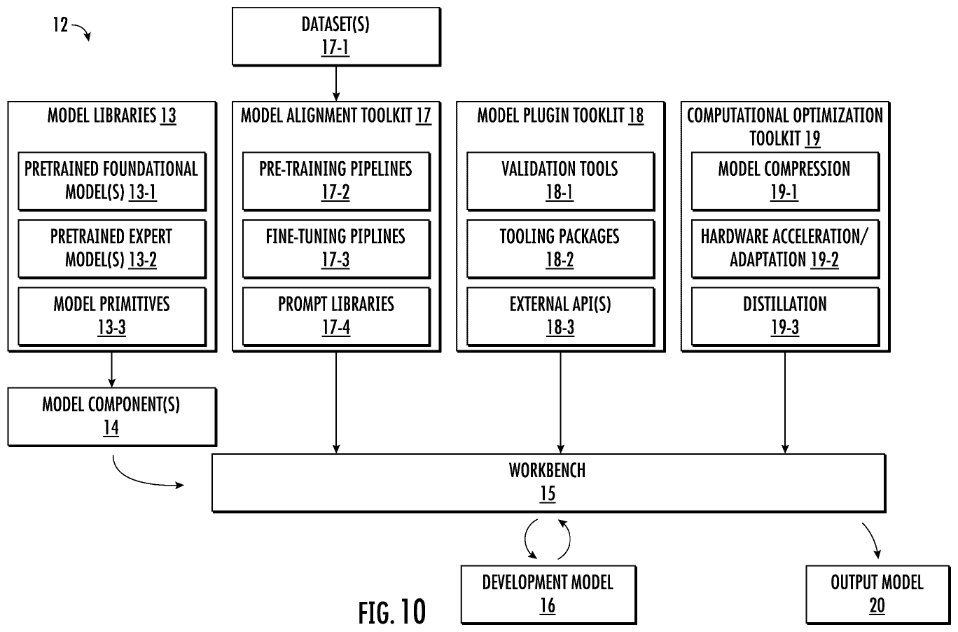

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models-e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

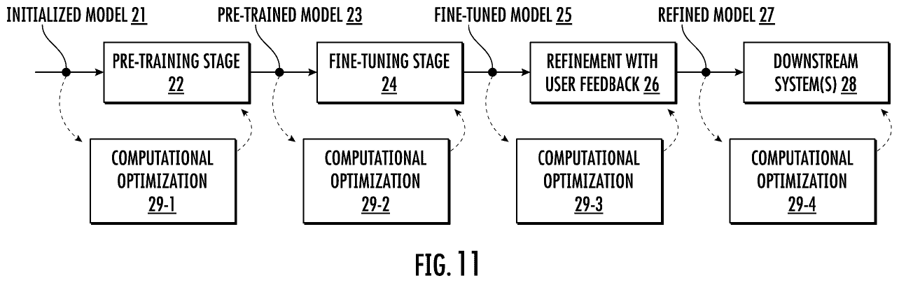

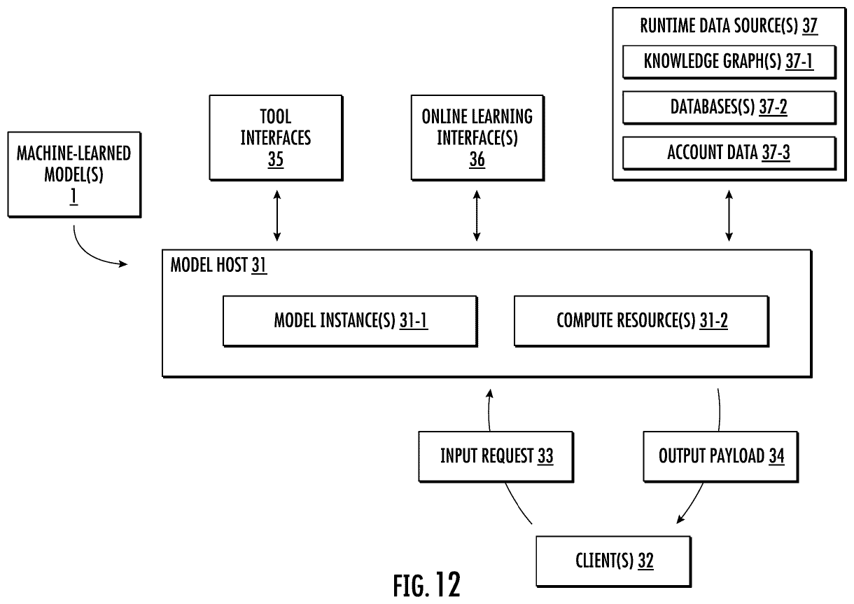

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32.

Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance.

Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

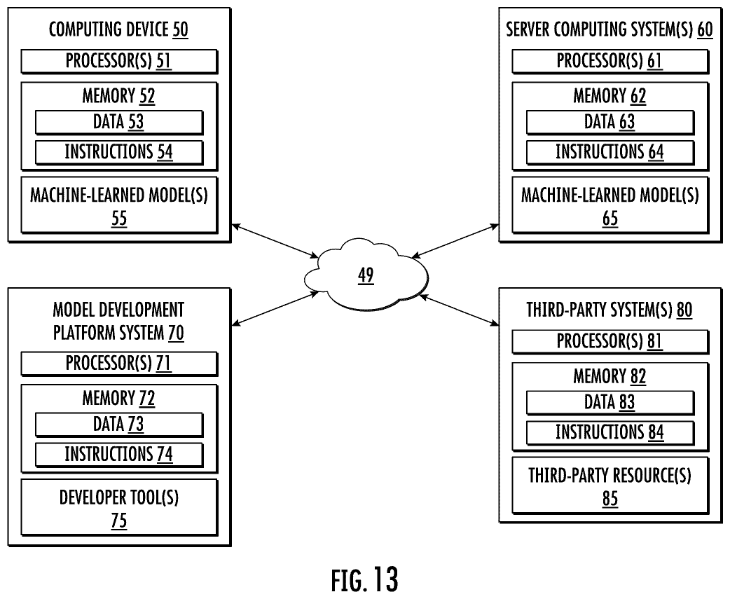

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

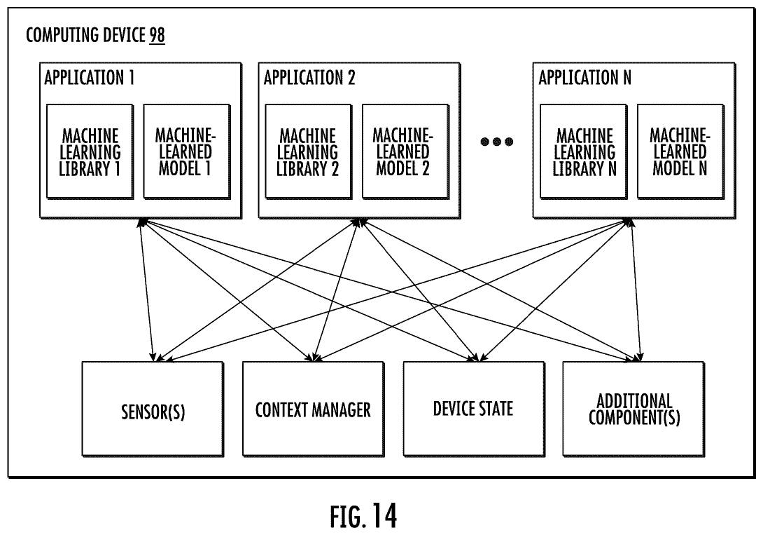

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

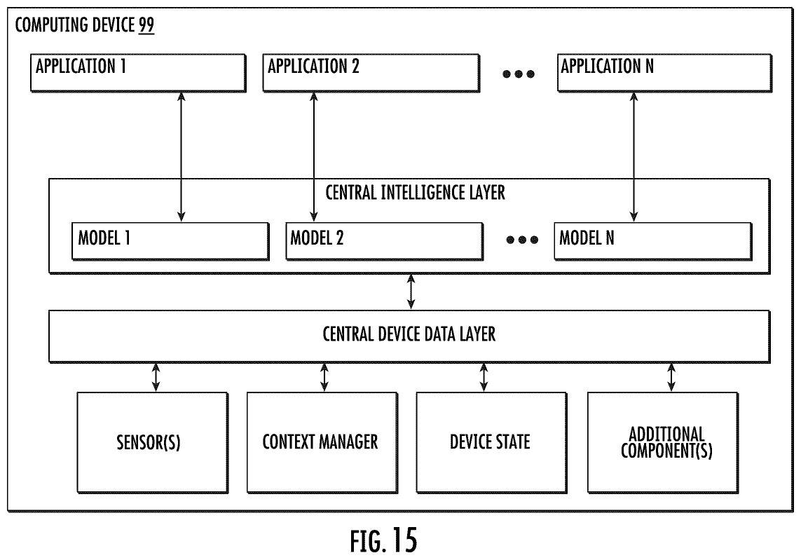

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method, comprising:
receiving, by a computing system with one or more processors, a query;
generating, by the computing system using a retrieval augmented generation system, a set of retrieval results based on the query;
determining, by the computing system, a diversity score for the set of retrieval results;
in accordance with a determination that the diversity score for the set of retrieval results exceeds a threshold value:
generating, by the computing system, a plurality of retrieval result clusters based on the set of retrieval results;
obtaining, by the computing system, a plurality of representative items, each representative item representing a respective retrieval result cluster in the plurality of retrieval result clusters;
transmitting, by the computing system, the plurality of representative items for display to a user;
receiving, by the computing system, selection data, wherein the selection data represents selection of one or more of the plurality of representative items by the user; and
updating, by the computing system, the set of retrieval results based on the selection data by removing search results associated with one or more retrieval result clusters from the set of retrieval results; and
processing, by the computing system, the query using a generative machine-learned model to produce a model response to the query, wherein the updated set of retrieval results is provided to the generative machine-learned model as context to the query.

2. The computer-implemented method of claim 1, wherein the retrieval results comprise supplemental information provided as contextual information to the generative machine-learned model.

3. The computer-implemented method of claim 2, wherein the retrieval results comprise embedded documents retrieved from a knowledge base.

4. The computer-implemented method of claim 3, wherein determining, by the computing system, the diversity score for the set of retrieval results further comprises:
calculating, by the computing system, a centroid of the embedded documents; and
determining, by the computing system, the diversity score based on an average distance from each retrieval result to the centroid.

5. The computer-implemented method of claim 1, wherein the threshold value is a predetermined diversity threshold.

6. The computer-implemented method of claim 1, wherein a number of retrieval result clusters in the plurality of retrieval result clusters is predetermined.

7. The computer-implemented method of claim 1, wherein a number of retrieval result clusters in the plurality of retrieval result clusters is determined based on an analysis of the retrieval results.

8. The computer-implemented method of claim 1, wherein obtaining, by the computing system, the plurality of representative items further comprises:
generating, by the computing system using the generative machine-learned model or a different generative machine-learned model, the plurality of representative items.

9. The computer-implemented method of claim 1, wherein obtaining, by the computing system, the plurality of representative items further comprises:
for a respective retrieval result cluster in the plurality of retrieval result clusters:
determining, by the computing system, a semantic label for the respective retrieval result cluster; and
retrieving, by the computing system, a representative time for the semantic label from a database of representative items.

10. The computer-implemented method of claim 1, wherein obtaining, by the computing system, the plurality of representative items further comprises:
selecting, by the computing system, a representative item for a respective retrieval result cluster from content included in the retrieval results included in the respective retrieval result cluster.

11. The computer-implemented method of claim 10, wherein the representative item for a respective retrieval result cluster comprise a labelled image extracted from a retrieval result included in the respective retrieval result cluster.

12. The computer-implemented method of claim 1, wherein a number of obtained representative items is based on a number of retrieval result clusters in the plurality of retrieval result clusters and a cluster size of one or more retrieval result clusters in the plurality of retrieval result clusters.

13. The computer-implemented method of claim 1, wherein the selection data comprises data indicating a user selection of a specific representative item associated with a specific retrieval result cluster in the plurality of retrieval result clusters.

14. The computer-implemented method of claim 11, wherein updating, by the computing system, the set of retrieval results based on the selection data further comprising:
generating, by the computing system, the updated set of retrieval results by filtering the set of retrieval results to remove retrieval results from retrieval result clusters not in the specific retrieval result cluster.

15. The computer-implemented method of claim 11, wherein updating, by the computing system, the set of retrieval results based on the selection data further comprises:
generating, by the computing system, an updated input query based on the selection data; and
generating, by the computing system, an updated set of retrieval results based on the updated input query.

16. The computer-implemented method of claim 1, wherein the selection data comprises data indicating that no representative item was selected.

17. The computer-implemented method of claim 14, the computer-implemented method further comprising:
determining, by the computing system, that the selection data does not include selection of any of the representative items; and
responsive to determining that the selection data does not include selection of any of the representative items, transmitting, by the computing system, a request for further clarification of the query.

18. A computing system comprising one or more processors and one or more non-transitory computer-readable media storing instructions that are executable by the one or more processors to cause the computing system to perform operations, the operations comprising:
receiving an input query;
generating a set of retrieval results based on the input query using a retrieval augmented generation system;
determining a diversity score for the set of retrieval results;
in accordance with a determination that the diversity score for the set of retrieval results exceeds a threshold value:
generating a plurality of retrieval result clusters based on the set of retrieval results;
obtaining a plurality of representative items, each representative item representing a respective retrieval result cluster in the plurality of retrieval result clusters;
transmitting the plurality of representative items to a user computing device for display to a user;
receiving, from the user computing device, selection data generated by user interaction with the plurality of representative items; and
updating the set of retrieval results based on the selection data by removing search results associated with one or more retrieval result clusters from the set of retrieval results; and
providing the input query and the updated set of retrieval results as input to a generative machine-learned model, wherein the updated set of retrieval results is provided to the generative machine-learned model as context to the input query; and
receiving model output from the generative machine-learned model.

19. The computing system of claim 18, wherein a number of retrieval result clusters in the plurality of retrieval result clusters is determined based on an analysis of the retrieval results.

20. One or more non-transitory computer-readable media storing instructions that are executable by one or more processors to cause a computing system to perform operations, the operations comprising:
receiving an input query;
generating a set of retrieval results based on the input query using a retrieval augmented generation system;
determining a diversity score for the set of retrieval results;
in accordance with a determination that the diversity score for the set of retrieval results exceeds a threshold value:
generating a plurality of retrieval result clusters based on the set of retrieval results;
obtaining a plurality of representative items, each representative item representing a respective retrieval result cluster in the plurality of retrieval result clusters;
transmitting the plurality of representative items to a user computing device for display to a user;
receiving, from the user computing device, selection data generated by user interaction with the plurality of representative items; and
updating the set of retrieval results based on the selection data by removing search results associated with one or more retrieval result clusters from the set of retrieval results; and
providing the input query and the updated set of retrieval results as input to a generative machine-learned model, wherein the updated set of retrieval results is provided to the generative machine-learned model as context to the input query; and
receiving model output from the generative machine-learned model.
